(19) United States
(12) Patent Application Publication
(10) Pub. No.: US 2023/0022291 A1
(43) Pub. Date: Jan. 26, 2023

(54) PROPULSION ASSEMBLY FOR AN AIRCRAFT

(71) Applicants: Airbus SAS, BLAGNAC (FR); Airbus Operations SAS, TOULOUSE (FR)

(72) Inventors: Jorge A. CARRETERO BENIGNOS, TAUFKIRCHEN (DE); Lionel CZAPLA, TOULOUSE (FR)

(21) Appl. No.: 17/870,052

(22) Filed: Jul. 21, 2022

(30) Foreign Application Priority Data
Jul. 26, 2021 (FR) 2108076

(51) Int. Cl. B64D 27/26; B64D 29/06; B64D 37/02; B64D 33/02; B64D 33/04

(52) U.S. Cl. CPC B64D 27/26; B64D 29/06; B64D 37/02; B64D 33/02; B64D 33/04; B64D 2033/024

(57) ABSTRACT

A propulsion assembly for an aircraft, comprising a nacelle, a propulsion system housed in the nacelle and comprising a fairing, a rotary assembly that has a combustion chamber and is housed in the fairing, an exhaust nozzle delimited by a nozzle wall of the fairing, a fuel tank, a supply duct which connects the tank and the combustion chamber, and a heat exchanger system ensuring, during operation of the propulsion system, an exchange of heat energy between the hot combustion gases circulating in the nozzle and the colder fuel circulating in the supply duct by thermal radiation through the nozzle wall.

### CROSS-REFERENCES TO RELATED APPLICATIONS

This application claims the benefit of the French patent application No. 2108076 filed on Jul. 26, 2021, the entire disclosures of which are incorporated herein by way of reference.

### FIELD OF THE INVENTION

The present invention relates to a propulsion assembly for an aircraft, the propulsion assembly comprising a propulsion system having an exhaust nozzle which discharges the combustion gases from the propulsion system and a heat exchanger arranged at the exhaust nozzle for ensuring heat energy is transferred to the fuel of the propulsion system, and to an aircraft having at least one such propulsion system.

### BACKGROUND OF THE INVENTION

In order to be moved, an aircraft conventionally has at least one propulsion assembly comprising a propulsion system arranged in a nacelle and which may take the form of a turbojet engine or a turboprop engine. In each case, the propulsion system has a rotary assembly which drives a fan or a propeller. The rotary assembly constitutes a core of the propulsion system and, from the front to the rear, it has an air inlet which allows the introduction of air into a duct of the core, a compressor which compresses the air thus introduced, a combustion chamber in which the air thus compressed is mixed with a fuel, and a turbine which allows the combustion gases to expand and which generates the rotation which is transmitted to the fan or to the propeller.

Downstream of the turbine, an exhaust nozzle ensures the discharge of the combustion gases.

It is also known, in particular in the case of dihydrogen, that the efficiency of the combustion of a fuel is improved if this fuel is heated before the combustion. It is also known to use a portion of the hot combustion gases discharged by the exhaust nozzle to heat the fuel.

### SUMMARY OF THE INVENTION

An object of the present invention is to propose another solution for heating the fuel before its combustion without bleeding the combustion gases.

To that end, what is proposed is a propulsion assembly for an aircraft, having:
a nacelle,
a propulsion system arranged inside the nacelle and comprising a fairing, a combustion chamber and, housed in the fairing, an exhaust nozzle positioned downstream of the combustion chamber and delimited by a rear portion of the fairing, referred to as nozzle wall, and ensuring the discharge of the combustion gases originating from the combustion of the fuel in the combustion chamber,
a fuel tank,
a supply duct which connects the tank and the combustion chamber, and
a heat exchanger system ensuring, during operation of the propulsion system, an exchange of heat energy between the hot combustion gases circulating in the nozzle and the colder fuel circulating in the supply duct by thermal radiation through the nozzle wall.

According to the invention, the heat exchanger system has a portion of the supply duct, wherein the portion takes the form of a cowling which is sealingly fixed to the nozzle wall and on the outside thereof, and wherein the cowling and the nozzle wall define between them a heating chamber for the fuel; the cowling is fitted with multiple guiding walls which divide the heating chamber into multiple successive corridors communicating one with the next; and a space is provided between each guiding wall and the nozzle wall.

With such an arrangement, the heat energy of the combustion gases is transferred to the fuel for better combustion without bleeding the combustion gases.

Advantageously, the propulsion assembly has leak detection means provided at the portion, a control unit connected to the leak detection means, and a valve mounted on the supply duct downstream of the portion and made to open and close by the control unit.

According to a specific embodiment, the heat exchanger system has a circulation duct in which a heat transfer fluid circulates, a pump arranged so as to move the heat transfer fluid in the circulation duct, wherein a portion of the circulation duct takes the form of a cowling which is sealingly fixed to the nozzle wall and on the outside thereof, and wherein the cowling and the nozzle wall define between them a heating chamber for the heat transfer fluid.

Advantageously, the cowling is made of the same material as the nozzle wall.

Advantageously, the cowling extends over an angular sector that is limited around an axis of the nozzle wall.

Advantageously, the cowling extends over the entire perimeter of the nozzle wall.

Advantageously, the guiding walls are parallel to an axis of the nozzle wall.

Advantageously, the guiding walls are perpendicular to an axis of the nozzle wall.

Advantageously, the nozzle wall is fitted with ribs which extend parallel to the guiding walls and each rib is positioned between two consecutive guiding walls.

The invention also proposes an aircraft having at least one propulsion assembly according to one of the variants above.

### BRIEF DESCRIPTION OF THE DRAWINGS

The features of the invention mentioned above, along with others, will become more clearly apparent upon reading the following description of one exemplary embodiment, the description being given with reference to the appended drawings, in which:

FIG. 1 is a side view of an aircraft having a propulsion assembly according to the invention,

FIG. 2 is a schematic representation in a side view and in section of a propulsion assembly according to a first embodiment of the invention,

FIG. 3 is a schematic representation in a side view and in section of a propulsion assembly according to a second embodiment of the invention,

FIG. 4 is a perspective view of a heat exchanger system according to one embodiment of the invention,

FIG. 5 is a view in section, through a plane perpendicular to the axis of the nozzle, of a heat exchanger system according to a variant embodiment of the invention,

FIG. 6 is a view in section, through a plane perpendicular to the axis of the nozzle, of a heat exchanger system according to a variant embodiment of the invention,

FIG. 7 is a view in section, through a plane perpendicular to the axis of the nozzle, of a heat exchanger system according to a variant embodiment of the invention, and

FIG. 8 is a perspective view of another heat exchanger system according to one embodiment of the invention.

### DETAILED DESCRIPTION OF THE PREFERRED EMBODIMENTS

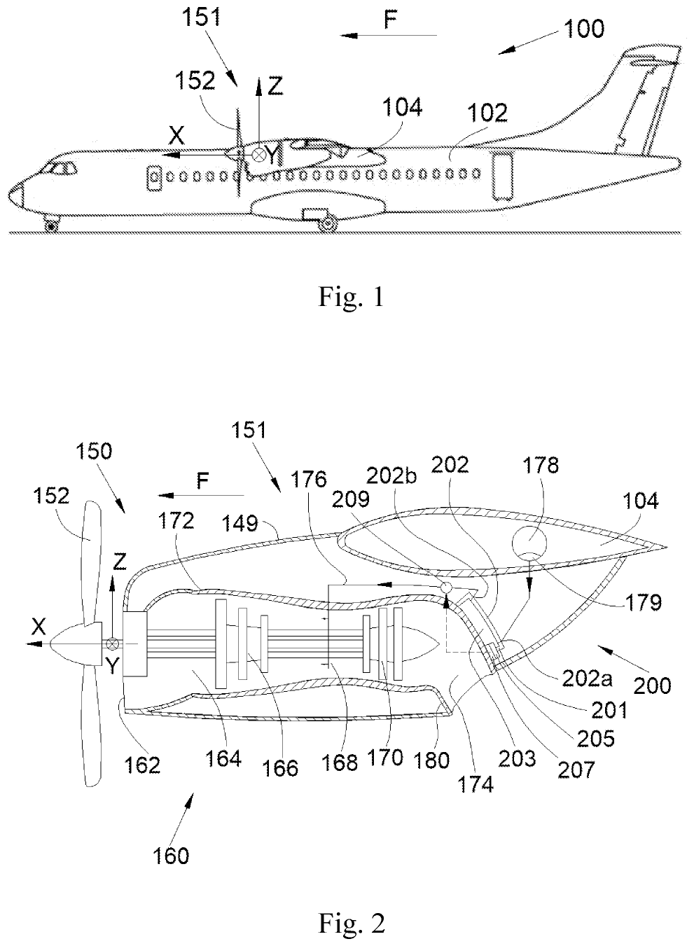

In the following description, the terms relating to a position are considered in relation to an aircraft in a position of forward movement, that is to say, as shown in FIG. 1, in which the arrow F shows the direction of forward movement of the aircraft.

FIG. 1 shows an aircraft 100 that has a fuselage 102, on either side of which is fixed a wing 104. At least one propulsion system 151 is fixed under each wing 104.

FIG. 2 shows the propulsion assembly 151, which has a nacelle 149 and a propulsion system 150 surrounded by the nacelle 149. In the embodiment of the invention presented here, each propulsion system 150 takes the form of a turboprop engine with a propeller 152 driven in rotation by a rotary assembly mounted inside a fairing 172 of the propulsion system 150 housed inside the nacelle 149, but each propulsion system 150 may also take the form of a turbojet engine driving a fan. Thus, the propulsion system 150 generally has a rotary assembly and a movable element 152 (propeller or fan). The fairing 172 is sealed.

In the following description, and by convention, X refers to the longitudinal axis, which corresponds to the axis of rotation of the movable element 152 with positive orientation in the direction of forward movement of the aircraft 100; Y refers to the transverse axis, which is horizontal when the aircraft is on the ground; and Z refers to the vertical axis or vertical height when the aircraft is on the ground; these three axes X, Y and Z being mutually orthogonal.

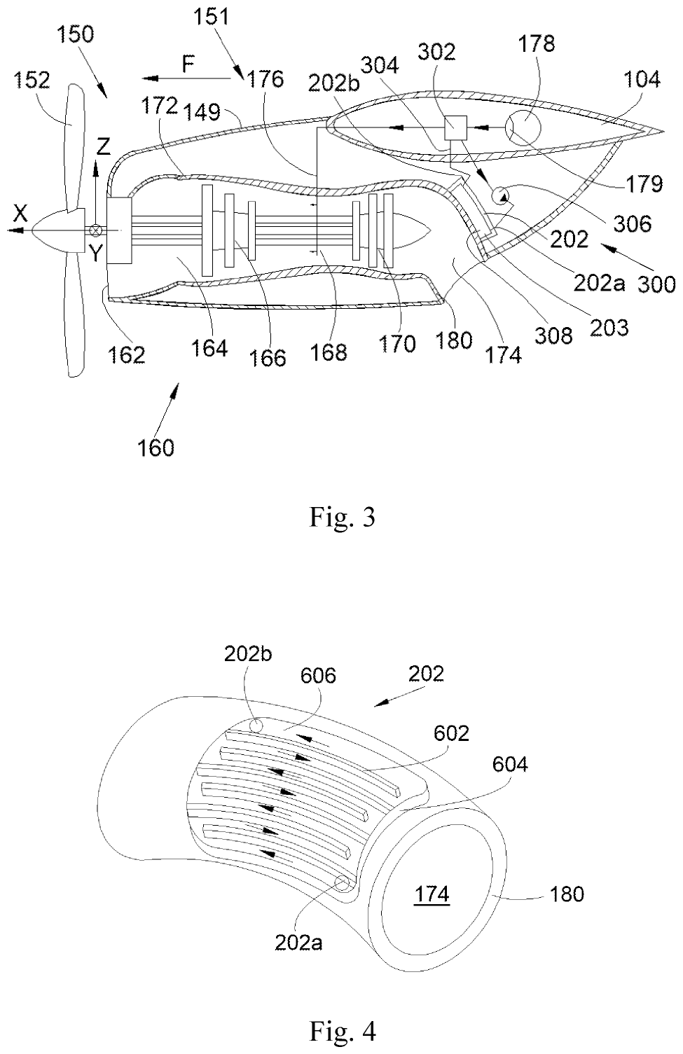

FIG. 2 and FIG. 3 show the propulsion system 150 in the case of a turboprop engine. The rotary assembly 160 constitutes a core of the propulsion system 150 and, from the front to the rear, it has an air inlet 162 which allows the introduction of air into a duct 164 of the core, a compressor 166 which compresses the air thus introduced, a combustion chamber 168 in which the air thus compressed is mixed with a fuel and the mixture is burned, and a turbine 170 which allows the combustion gases to expand and which generates the rotation which is transmitted to the movable element, in this instance the propeller 152. The elements of the rotary assembly 160 are surrounded by the fairing 172 formed of structural casings which are mounted around the elements of the rotary assembly 160 and make it possible to stiffen it, in order, in particular, to limit distortions thereof during operation. In the rotary assembly, some elements of the rotary assembly can rotate about the axis X, whereas some elements of the rotary assembly are fixed, but contribute to the driving in rotation of the rotary elements of the rotary assembly.

The fairing 172 is, on the one hand, open to the front at the air inlet 162 and delimits the duct 164 and is, on the other hand, open to the rear at an exhaust nozzle 174 which is downstream of the turbine 170 and therefore of the combustion chamber 168 and ensures the discharge of the combustion gases originating from the combustion of the fuel and the air in the combustion chamber 168. The rear part of the fairing 172 that surrounds the exhaust nozzle 174 forms the nozzle wall 180.

The space between the nacelle 149 and the fairing 172 is occupied by various systems which ensure the operation of the propulsion system 150. In particular, in order to supply fuel to the combustion chamber 168, the propulsion assembly 151 has a fuel tank 178 which in this instance is housed in the wing 104, a supply duct 176 which connects the tank 178 and the combustion chamber 168, and a pump 179 which moves the fuel from the tank 178 to the combustion chamber 168 through the supply duct 176. The fuel may be kerosene or dihydrogen (H2), for example.

In order to heat the fuel before it is injected into the combustion chamber 168, so as to achieve better combustion, the propulsion assembly 151 also has a heat exchanger system 200, which is arranged in the space between the nacelle 149 and the fairing 172, and which is arranged, when the propulsion system 150 is in operation, to ensure heat energy is exchanged between the hot combustion gases circulating in the nozzle 174 and the colder fuel circulating in the supply duct 176. This transfer of heat energy is done by thermal radiation through the nozzle wall 180 which is brought to high temperature during the operation of the propulsion system 150.

In the embodiment of FIG. 2, the heat exchanger system 200 has a portion 201 of the supply duct 176, wherein the portion 201 is fixed in the space between the nacelle 149 and the fairing 172 at the nozzle wall 180.

The portion 201 takes the form of a cowling 202 which is sealingly fixed to the nozzle wall 180 and on the outside thereof, and the cowling 202 and the nozzle wall 180 define between them a heating chamber 203 for the fuel. The cowling 202 is made for example from a stamped/folded metal sheet.

The cowling 202 is fitted with an inlet connection 202a which ensures the transfer of fluid from the outside of the cowling 202 toward the heating chamber 203 and with an outlet connection 202b which ensures the transfer of fluid from the heating chamber 203 toward the outside of the cowling 202.

The supply duct 176 is thus divided into a first part which is fluidically connected between the tank 178 and the inlet connection 202a, a second part which is fluidically connected between the outlet connection 202b and the combustion chamber 168, and, between the first part 202a and the second part 202b, an intermediate part which is constituted by the cowling 202 and the heating chamber 203.

In this way, the fuel is heated directly in the heating chamber 203, which thereby constitutes a part of the supply duct 176.

In order to prevent a fuel leak at the portion 201, the heat exchanger system 200 has leak detection means 205 provided at the portion 201 and a control unit 207 connected to the leak detection means 205. The heat exchanger system 200 also has a valve 209 mounted on the supply duct 176 downstream of the portion 201 with respect to the direction of flow of the fuel and made to open and close by the control unit 207. The control unit 207 makes the valve 209 close when the leak detection means 205 detect a fuel leak.

In the embodiment of FIG. 3, the heat exchanger system 300 has a circulation duct 304 in which a heat transfer fluid circulates, a pump 306 arranged so as to move the heat transfer fluid in the circulation duct 304, wherein a portion 308 of the circulation duct 304 is arranged in the space between the nacelle 149 and the fairing 172 at the nozzle wall 180.

The portion 308 takes the form of a cowling 202 which is sealingly fixed to the nozzle wall 180 and on the outside thereof, and the cowling 202 and the nozzle wall 180 define between them a heating chamber 203 in order to ensure a transfer of heat energy from the combustion gases to the heat transfer fluid. The heat exchanger system 300 also has a heat exchanger 302 arranged between the supply duct 176 and the circulation duct 304 so as to ensure a transfer of heat energy from the heat transfer fluid to the fuel. In this way, the fuel is heated indirectly via a heat transfer fluid.

As above, the cowling 202 is fitted with an inlet connection 202a which ensures the transfer of fluid from the outside of the cowling 202 toward the heating chamber 203 and with an outlet connection 202b which ensures the transfer of fluid from the heating chamber 203 toward the outside of the cowling 202.

The supply duct 304 is thus divided into a first part which is fluidically connected between the heat exchanger 302 and the inlet connection 202a, a second part which is fluidically connected between the outlet connection 202b and the heat exchanger 302, and, between the first part 308a and the second part 308b, an intermediate part which is constituted by the cowling 202 and the heating chamber 303.

In both cases, the cowling 202, 308 is preferably made of the same material as the nozzle wall 180 in order to behave identically with regard to the temperature and thus to avoid leaks between them.

FIG. 4 and FIG. 8 show perspective views of the nozzle wall 180 with the cowling 202 for arrangements which apply both in the embodiment of FIG. 1 and in the embodiment of FIG. 2. The cowling 202 takes the form of a trough which has a bottom 606, 806 and an opening which is held against the nozzle wall 180, the edges of which surrounding the opening are sealingly fixed to the nozzle wall 180, in particular by welding. The cowling 202 has rims 604, 804 which extend between the bottom 606, 806 and the opening on all sides of the cowling 202. The bottom 606, 806 is thus spaced apart from the nozzle wall 180 to form the heating chamber 203.

The difference between these two embodiments rests in the angular extent of the cowling 202 around the nozzle wall 180. In the embodiment of FIG. 4, the cowling 202 extends over an angular sector that is limited around the axis of the nozzle wall 180, in this instance of about 90°, and, in the embodiment of FIG. 8, the cowling 202 extends over the entire perimeter of the nozzle wall 180, that is to say 360°.

The inlet connection 202a and the outlet connection 202b are installed at the bottom 606, 806 but other positions are possible.

In a general manner, in order to ensure that the fluid (fuel, heat transfer fluid) expands as much as possible inside the cowling 202, the inlet connection 202a and the outlet connection 202b are as far apart as possible.

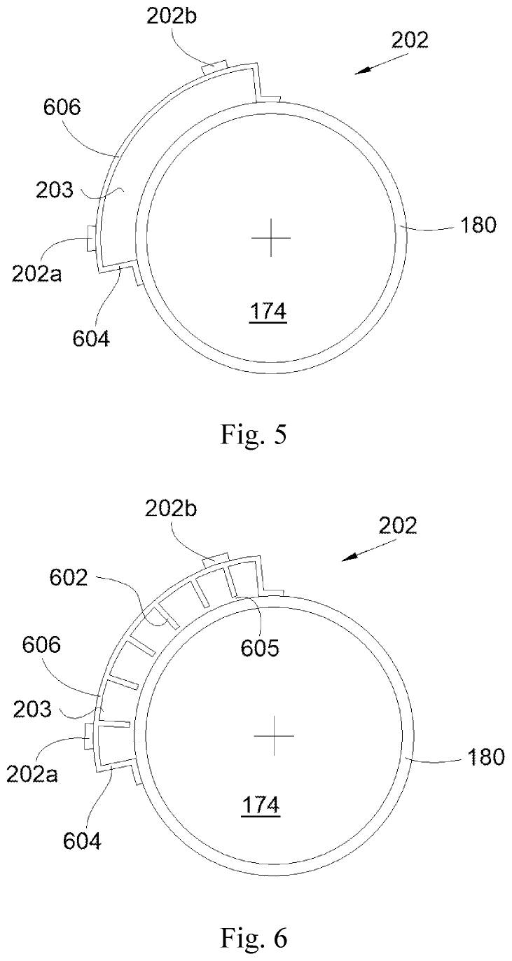

FIGS. 5 to 7 show various embodiments which make it possible to ensure better transfer of heat energy by lengthening the journey time of the fluid in the cowling 202. These arrangements apply equally to the embodiment of FIG. 4 and to the embodiment of FIG. 8.

In the embodiment of FIG. 5, the inside of the heating chamber 203 is completely open, allowing the fluid to flow without a drop in pressure.

In the embodiment of FIG. 6, the cowling 202 is fitted with multiple guiding walls 602 which divide the heating chamber 203 into multiple successive corridors and the guiding walls 602 are configured to ensure fluidic communication one with the next, that is to say, a corridor communicates fluidically with its two neighboring corridors, in order to lengthen the journey time of the fluid in the cowling 202. Each guiding wall 602 extends overall perpendicularly with respect to the bottom 606, thus forming a plurality of walls spaced apart from one another.

FIG. 4 shows a transparent view of an example of the position of the various guiding walls 602 when they are parallel to the axis of the nozzle wall 180.

FIG. 8 shows a transparent view of an example of the position of the various guiding walls 602 when they are perpendicular to the axis of the nozzle wall 180.

In the embodiment of FIG. 4, each guiding wall 602 has a free end which allows the passage of the fluid between the free end and one of the rims 604 of the cowling 202 and a closed end which bears against the opposite rim 604 of the cowling 202 to prevent the passage of the fluid. For two consecutive guiding walls 602, the positions of the free end and of the closed end are reversed, so as to thus form baffles which channel the fluid.

In the embodiment of FIG. 8, a passage 802, which allows flow from one corridor to the other, is made in each guiding wall 602 and in this instance, for two consecutive guiding walls 602, the passages 802 are diametrically opposite with respect to the axis of the nozzle wall 180.

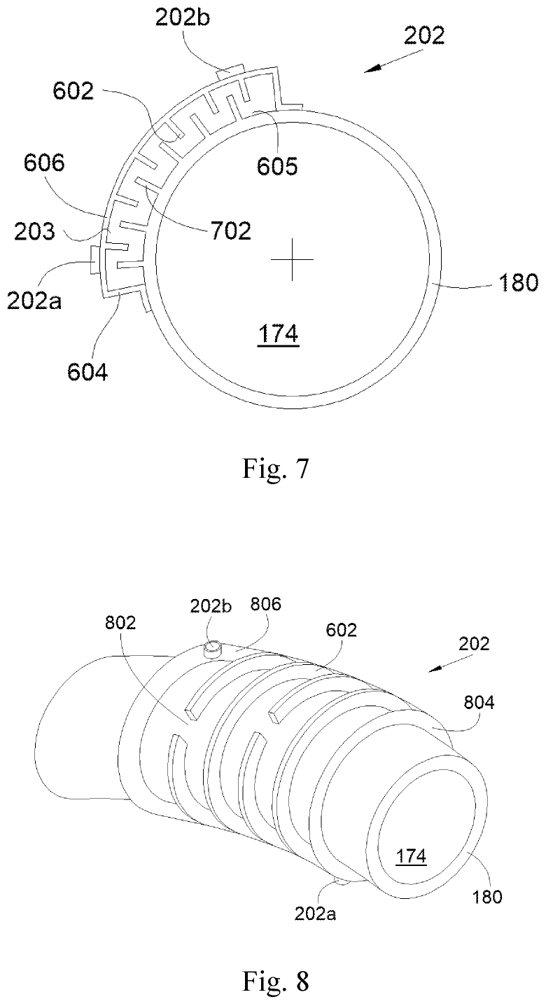

The features presented in FIGS. 6 and 7 are more particularly presented for guiding walls 602 that are parallel to the axis of the nozzle wall 180, but they apply in the same way for guiding walls 602 that are perpendicular to the axis of the nozzle wall 180.

In FIG. 6, a space 605 between each guiding wall 602 and the nozzle wall 180 is provided in order to avoid contact between them. The space 605 is, for example, 5 mm, in order to limit the recirculation of the fluid via this space.

In FIG. 7, the nozzle wall 180 is fitted with ribs 702 which also extend overall perpendicularly with respect to the bottom 606 and parallel to the guiding walls 602 and each rib 702 is positioned between two consecutive guiding walls 602 in order to further limit the recirculation of the fluid under the guiding walls 602.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion assembly for an aircraft, comprising:
a nacelle,
a propulsion system arranged inside the nacelle and comprising a fairing, a combustion chamber and, housed in the fairing, an exhaust nozzle positioned downstream of the combustion chamber and delimited by a rear portion of the fairing, referred to as a nozzle wall, and ensuring a discharge of combustion gases originating from a combustion of fuel in the combustion chamber,
a fuel tank,
a supply duct which connects the tank and the combustion chamber, and
a heat exchanger system ensuring, during operation of the propulsion system, an exchange of heat energy between the hot combustion gases circulating in the nozzle and the colder fuel circulating in the supply duct by thermal radiation through the nozzle wall,
wherein the heat exchanger system has a portion of the supply duct, wherein said portion forms a cowling which is sealingly fixed to the nozzle wall and on the outside thereof, and wherein the cowling and the nozzle wall define between them a heating chamber for the fuel,
the cowling being fitted with multiple guiding walls which divide the heating chamber into multiple successive corridors communicating one with the next, and
a space being provided between each guiding wall and the nozzle wall.

2. The propulsion assembly as claimed in claim 1, further comprising:
leak detection means provided at said portion,
a control unit connected to the leak detection means, and
a valve mounted on the supply duct downstream of the portion and made to open and close by the control unit.

3. The propulsion assembly as claimed in claim 1, wherein the heat exchanger system has a circulation duct in which a heat transfer fluid circulates, a pump arranged so as to move the heat transfer fluid in the circulation duct, wherein a portion of the circulation duct forms a cowling which is sealingly fixed to the nozzle wall and on the outside thereof, and wherein the cowling and the nozzle wall define between them a heating chamber for the heat transfer fluid.

4. The propulsion assembly as claimed in claim 1, wherein the cowling is made of the same material as the nozzle wall.

5. The propulsion assembly as claimed in claim 1, wherein the cowling extends over an angular sector that is limited about an axis of the nozzle wall.

6. The propulsion assembly as claimed in claim 1, wherein the cowling extends over an entire perimeter of the nozzle wall.

7. The propulsion assembly as claimed in claim 1, wherein the guiding walls are parallel to an axis of the nozzle wall.

8. The propulsion assembly as claimed in claim 1, wherein the guiding walls are perpendicular to an axis of the nozzle wall.

9. The propulsion assembly as claimed in claim 1, wherein the nozzle wall is fitted with ribs which extend parallel to the guiding walls and each rib is positioned between two consecutive guiding walls.

10. An aircraft having at least one propulsion assembly as claimed in claim 1.
